(19) United States
(12) Patent Application Publication
(10) Pub. No.: US 2019/0369892 A1
(43) Pub. Date: Dec. 5, 2019

(54) Method and Apparatus for Facilitating a Trim Process Using Auxiliary Tables

(71) Applicant: CNEX Labs, Inc., San Jose, CA (US)

(72) Inventors: Yiren Ronnie Huang, San Jose, CA (US); Seong No Lee, Cupertino, CA (US)

(73) Assignee: CNEX Labs, Inc., San Jose, CA (US)

(21) Appl. No.: 16/425,913

(22) Filed: May 29, 2019

Related U.S. Application Data
(60) Provisional application No. 62/678,849, filed on May 31, 2018.

(51) Int. Cl. G06F 3/06; G06F 12/06

(52) U.S. Cl. CPC G06F 3/0632; G06F 12/0646; G06F 3/0634; G06F 2212/1016; G06F 3/0688; G06F 2212/1032; G06F 3/0619

(57) ABSTRACT

A method for processing a trim command via an input and output (“I/O”) command of a solid-state drive (“SSD”) using various tables is disclosed. The process is able to retrieve a trim node state table (“TNST”) from a local memory in response to the trim command. Upon identifying current node status of the TNST associated with a logical block address (“LBA”) referenced by the trim command, a trim operation is processed to a node if the current node status indicates a pending state. After changing the node status to a dirty state when the current node status is in a clean state, the content of a trim invalid bitmap table (“TIBT”) is updated to indicate the status of LBAs when the current node status is in a dirty state.

### PRIORITY

This application claims the benefit of priority based upon U.S. Provisional Patent Application Ser. No. 62/678,849, filed on May 31, 2018 in the name of the same inventor and entitled “Method and Apparatus for Facilitating A Trim Process Using Auxiliary Tables” the disclosure of which is hereby incorporated into the present application by reference.

### FIELD

The exemplary embodiment(s) of the present invention relates to the field of semiconductor and integrated circuits. More specifically, the exemplary embodiment(s) of the present invention relates to storage recycling in the non-volatile memory (“NVM”) storage devices.

### BACKGROUND

With increasing popularity of electronic devices, such as computers, smart phones, mobile devices, server farms, mainframe computers, and the like, the demand for more and faster data is constantly growing. To handle and facilitate voluminous data between such electronic devices, high speed NVM devices are typically required. A conventional type of NVM device, for example, is a flash-based storage device such as solid-state drive (“SSD”).

The flash-based SSD, for example, is an electronic NV storage device capable of maintaining, erasing, and/or reprogramming data. The flash memory can be fabricated with several different types of integrated circuit (“IC”) technologies such as NOR or NAND logic gates with, for example, floating-gate transistors. Depending on the applications, a typical memory access of flash memory can be configured to be a block, a page, a word, and/or a byte.

To mange storage space and storage recycling, a trim command, also known as TRIM, is used to allow the operating system or host to inform an SSD which blocks of data should be removed, recycled, and/or restored. For example, trim command enables the SSD to process garbage collection more efficiently. It should be noted that typical garbage collection takes longer time to complete whereby it can negatively impact write operations. However, a drawback associated with the trim is time consumption. Another drawback associated with the typical trim operation is the loss of information due to an unexpected power failure during an execution of a trim command.

### SUMMARY

One embodiment of the presently invention discloses a memory system able to provide a process of a trim command via an input and output (“I/O”) command of a solid-state drive (“SSD”) using various tables using trim context. The process retrieves a trim node state table (“TNST”) from a local memory in response to the trim command. Upon identifying current node status of the TNST associated with a logical block address (“LBA”) referenced by the trim command, a trim operation is processed to a node if the current node status indicates a pending state. After changing the node status to a dirty state when the current node status is in a clean state, the content of a trim invalid bitmap table (“TIBT”) is updated to indicate the status of the LBAs when the current node status is in a dirty state.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIGS. 1A-1B are block diagrams illustrating a system containing a host and an SSD capable of executing trim command efficiently using multiple tables in accordance with one embodiment of the present invention;

FIG. 2 is a block diagram illustrating NVM context and trim context coupled by I/O commands in accordance with one embodiment of the present invention;

FIGS. 3A-3B are block diagrams illustrating trim context containing multiple auxiliary tables in accordance with one embodiment of the present invention;

FIG. 4 is a flowchart showing a process of a write command using trim context in accordance with one embodiment of the present invention;

FIGS. 5-6 are flowcharts showing a process of a read command using a trim context in accordance with one embodiment of the present invention;

FIG. 7 is a flowchart illustrating a process of implementing trim context in accordance with one embodiment of the present invention; and

FIG. 8 is a block diagram illustrating a digital processing system capable of operating data storage using SSD with a trim process in accordance with one embodiment of the present invention.

### DETAILED DESCRIPTION

Embodiments of the present invention are described herein with context of a method and/or apparatus for recycling storage space for a nonvolatile memory (“NVM”).

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One embodiment of the presently claimed invention discloses an apparatus or method for processing a trim command via an input and output (“I/O”) command of a solid-state drive (“SSD”) using various table. The process, for example, is able to retrieve a trim node state table (“TNST”) from a local memory in response to the trim command. Upon identifying current node status of the TNST associated with a logical block address (“LBA”) referenced by the trim command, a trim operation is processed to a node if the current node status indicates a pending state. After changing the node status to a dirty state when the current node status is in a clean state, the content of a trim invalid bitmap table (“TIBT”) is updated to indicate the status of the LBAs when the current node status is in a dirty state.

In one aspect, a system includes a host and an SSD connected via a connection or a bus. The SSD includes an NVM, memory controller, and volatile memory wherein the volatile memory includes a TIBT, TNST, and TSBT for tracking recycling status associated with NVM. The NVM, able to store information persistently, is organized into blocks and pages addressable by logical block addresses (“LBAs”). The TIBT contains multiple entries wherein each entry is assigned to an LBA indicating recycling status. The TNST includes multiple nodes wherein each node points to a group of TIBT entries. The TSBT is configured to identify which dirty node within the TNST needs to be saved. During an operation, the apparatus is able to retrieve the TNST from the volatile memory and identify the current node status associated with the LBA in accordance with the TNST. While processing trim commands and I/O commands, trim node status changes between idle, pending, clean, and dirty states. It should be noted that managing trim context in node units could speed up overall processing trim performance. The TIBT, for example, is subsequently updated when the current node status is in a dirty state.

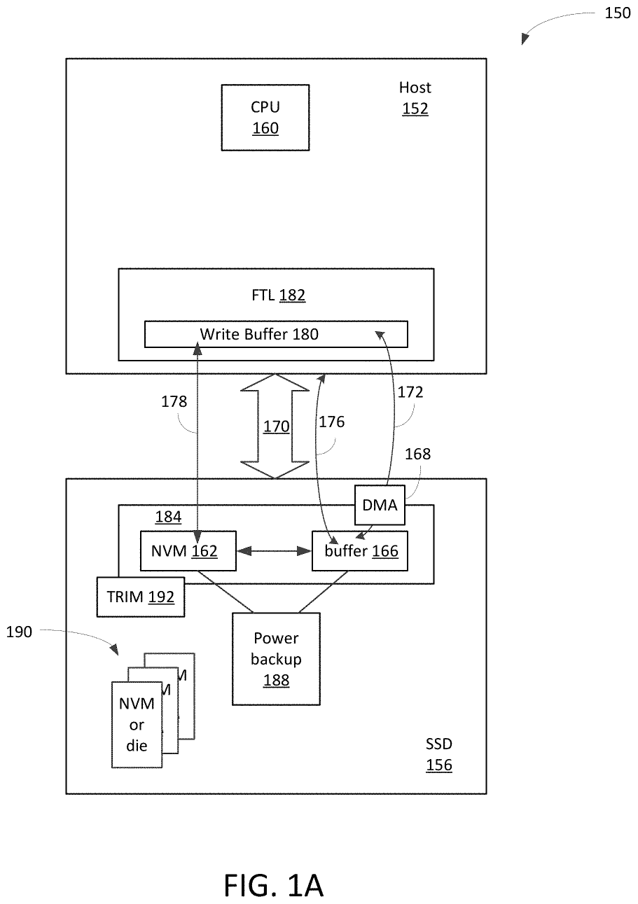

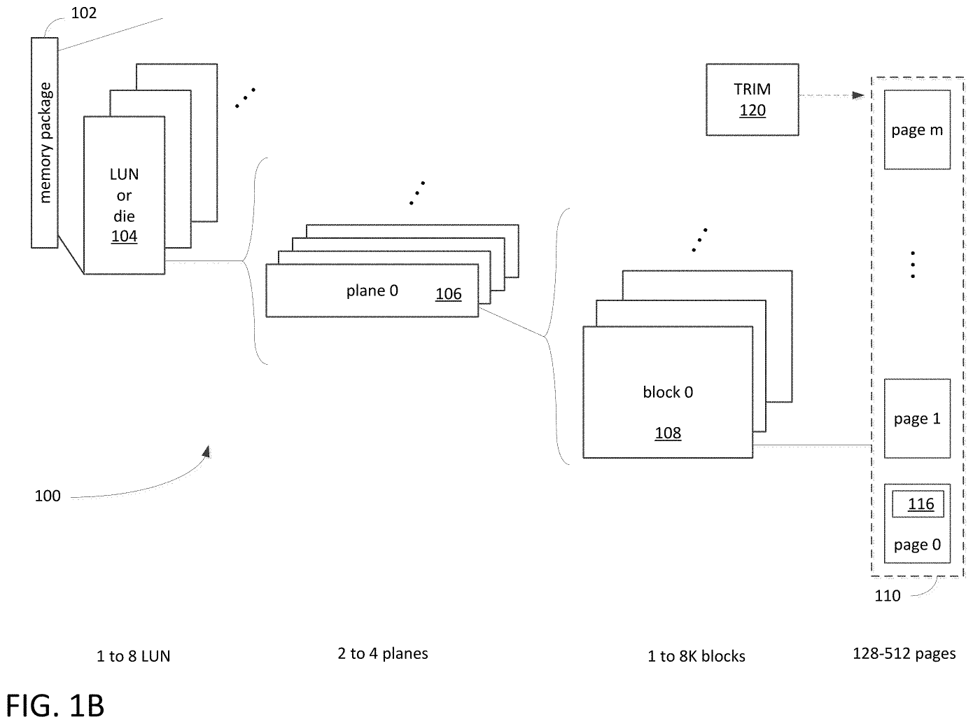

FIG. 1A is a block diagram 150 illustrating a system containing a host and an SSD configured to use trim context for recycling and/or restoring NVM in accordance with one embodiment of the present invention. Diagram 150 includes a host or host system 152, SSD 156, and bus 170. To provide and manage the NVM storage space, host 152 having a central processing unit (“CPU”) 160 and a flash translation layer (“FTL”) driver 182 for facilitating and transmitting trim commands. In one aspect, FTL driver 182 includes a write buffer 180 for facilitating write commands. It should be noted that the underlying concept of the exemplary embodiment(s) of the present invention would not change if one or more blocks (or devices) were added to or removed from diagram 150.

Bus 170 is used to couple Host 152 to SSD 156 for facilitating signal and/or information transfer. In one aspect, bus 170 is able to provide data communication for facilitating implementation of logic buses or connections 172-178. In one embodiment, buses 172-178 are part of bus 170. Alternatively, buses 172-178 can be independent buses other than bus 170. Bus 170 can be implemented by various bus protocols, such as, but not limited to, NVM Express (NVMe), PCI Express (PCIe), SATA Express, Serial ATA (SATA), Serial attached SCSI (SAS), Universal Serial Bus (USB), and the like.

Host 152 is a digital processing system capable of executing instructions. Host 152 can be referred to as a host system, computer system, computer, portable device, smart phone, server, router, switches, cloud storage and computing, autonomous vehicles, artificial intelligence system, and the like. To simplify the forgoing discussion, the term “host” is used to referred to any types of digital processing systems. During an operation, host 152 generally has the information regarding which LAB is old and ready be recycled and which LAB or LABs should be maintained. FTL drive 182, in one example, is used to facilitate storage or memory access including trim context to and from one or more SSDs.

SSD 156, also known as a solid-state NV memory storage, includes a driver or SSD driver 184, direct memory access (“DMA”) 168, memory controller, trim context 192, backup power 188, and NVMs 190. In one embodiment, SSD driver 184 further includes an NVM buffer 162 and a buffer 166. Buffer 166 which is a volatile memory can be a double data rate (“DDR”) buffer or memory configured to provide fast memory access. NVM buffer 162, in one embodiment, is used to handle trim commands. NVMs 190, which can be divided into LUN (logic unit number), block, and/or pages, are used to store data persistently. To simplify forgoing discussion, the terms “SSD” and “NVM storage” are referred to the similar devices and they can be used interchangeably.

Trim context 192 contains various tables for tacking recycling status of SSD 190. In one embodiment, a volatile memory is used to host trim context for fast turnaround. Trim context 192, coupled to SSD drive 184, controller, NVM 190, and backup power 188, is configured to be backed up upon detecting an unintended system power loss.

SSD driver 190, in one embodiment, is resided or situated in SSD or SSD 156 and capable of communicating with FTL 182 or host driver via an external bus such as bus 170. SSD driver 184 includes an SSD DDR buffer 166, NVM 162, and power supply or backup power supply 188. SSD DDR buffer 166 is used to store a copy of content similar to the content in write buffer 180. Backup power supply 188 coupled to SSD DDR buffer 166 and trim context 192 provides temporary power supply to buffer 162 and trim 192 when the power powering the system is lost. In one example, backup power supply 188 can be a capacitor.

The benefit(s) of using trim context is to improve efficiency for trim operations using one or more tables to indicate recycling status of NVM. A benefit of using trim context with a backup power is that at least a portion of the content of trim context can be saved before the system power and/or the backup power goes down.

FIG. 1B is a block diagram 100 illustrating an NVM device organized in LUNs, planes, blocks, and/or pages including a trim context 120 in accordance with one embodiment of the present invention. Diagram 100, capable of implementing a trim command, includes a memory package 102 which can be a memory chip containing one or more NVM dies or logic units (“LUNs”) 104. A flash memory, for example, has a hierarchy of Package-Silicon Die/LUN-Plane-Block-Flash Memory Page-Wordline configuration(s). It should be noted that the underlying concept of the exemplary embodiment(s) of the present invention would not change if one or more blocks (or devices) were added to or removed from diagram 100.

In one embodiment, an NVM memory device such as a flash memory package 102 contains one or more flash memory dies or LUNs wherein each LUN or die 104 is further organized into more NVM or flash memory planes 106. For example, die 104 may have a dual planes or quad planes. Each NVM or flash memory plane 106 can include multiple memory blocks or blocks. In one example, plane 106 can have a range of 1000 to 8000 blocks 108. Each block such as block 108 can have a range of 64 to 512 pages. For instance, a flash memory block can have 256 or 512 pages 110.

In one embodiment, a portion of a page or a block as indicated by numeral 116 is designated to store data or content from a local volatile memory when the power failure occurs. The local volatile memory, not shown in FIG. 1B, can be a RAM storage, DDR SDRAM (double data rate synchronous dynamic random-access memory), SRAM, or the like. In one aspect, the local volatile memory is supported by a capacitor which will be used to maintain the data integrity in the local volatile memory for a period of time so that the content of the local volatile memory can be loaded into non-volatile memory as indicated by numeral 116. In one example, the non-volatile memory is SLC (single level cell) type of NVM. SLC type of NVM, for example, has a fast access speed. Depending on the applications, the size of capacitor should be set to hold the data after power failure up to tens or hundreds of milliseconds.

Trim context 120, in one embodiment, is used to track recycling status for at least a portion of the NVM blocks and/or pages. A background trim operation can be executed in accordance with the information in trim context 120. Since trim context 120 is stored in the local volatile memory, trim context 120 will be saved in a predefined NVM location upon detection of a system power failure.

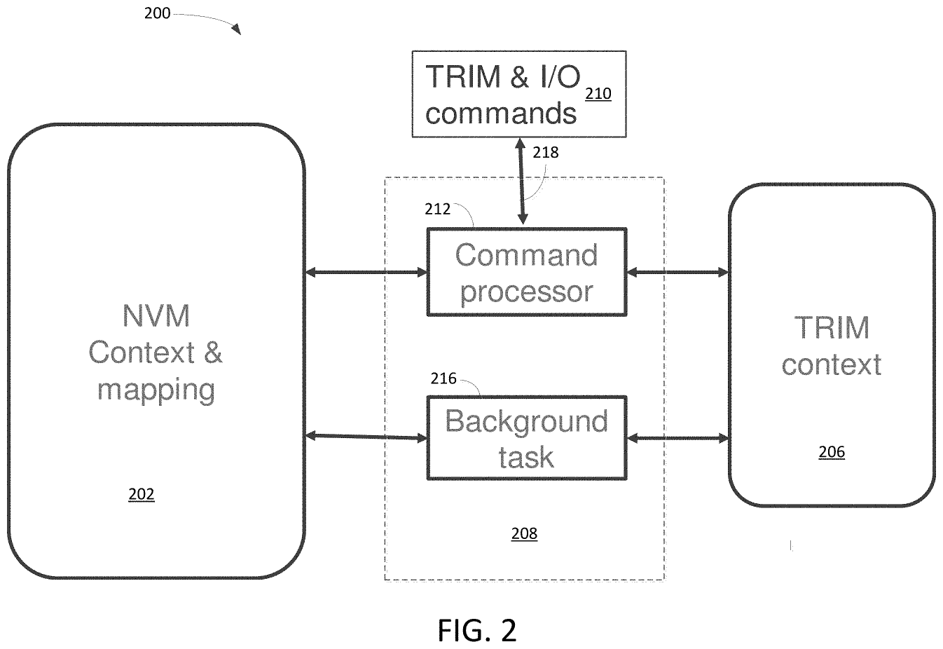

FIG. 2 is a block diagram 200 illustrating NVM context and trim context coupled by I/O commands in accordance with one embodiment of the present invention. Diagram 200 includes NVM context/mapping 202, trim context 206, and input output (“IO”) interface 208. IO interface 208, in one embodiment, is configured to receive and/or transmit trim related commands and background task instructions from host interface module 210. Host interface module 210, in one example, handles trim and I/O commands to and from the connected host, not shown in FIG. 2. It should be noted that the underlying concept of the exemplary embodiment(s) of the present invention would not change if one or more blocks (or devices) were added to or removed from diagram 200.

I/O interface 208 includes a command processor 212 and a background task module 216. Command processor 212, in one embodiment, is configured to handle communication between trim context 206, NVM context 202, and host interface module 210. Background task module 216, in one aspect, is configured to facilitate execution of trim command in background. It should be noted that a trim command or TRIM is a dataset management command instructing a connected SSD which portion or portions of data block should be deallocated and/or recycled.

In operation, the trim command, for example, facilitates recycling and creating more free space during a recycling or garbage collection process by deallocating storage space otherwise not used by the LBAs. Executing a trim command normally takes time to perform, update, and/or map logical locations to physical location in NVM context 202. Employing trim context 206 which tracks recycling status for the NVM pages and/or blocks should reduce response time for the trim command. For example, a scheme of returning early and processing later (background execution) can be implemented. In one embodiment, trim context 206 includes a volatile memory which is used to accumulate trim commands and facilitates background processing.

To improve trim context data integrity, a backup power to save it or at least a portion of it during an unintended power failure can be implemented. For example, a run-time snapshot scheme of trim context can be implemented to quickly identify which portion of the trim context should be saved during an unintended power failure. Using emergency backup system which backs up at least a portion of the trim context in the NVM, the interrupted execution of a trim command can be quickly resumed once the power is restored.

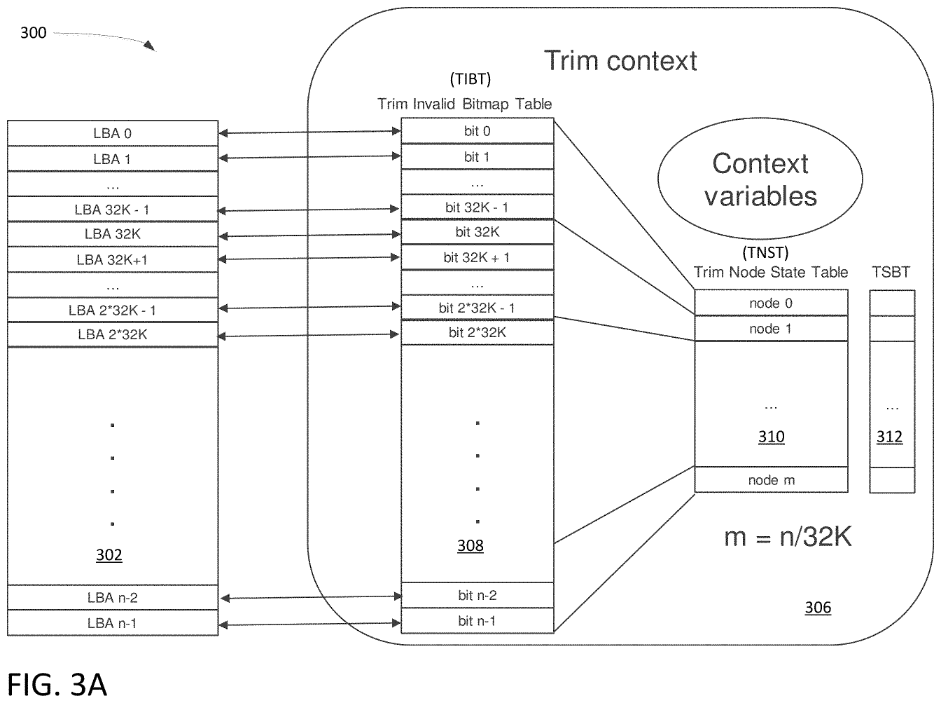

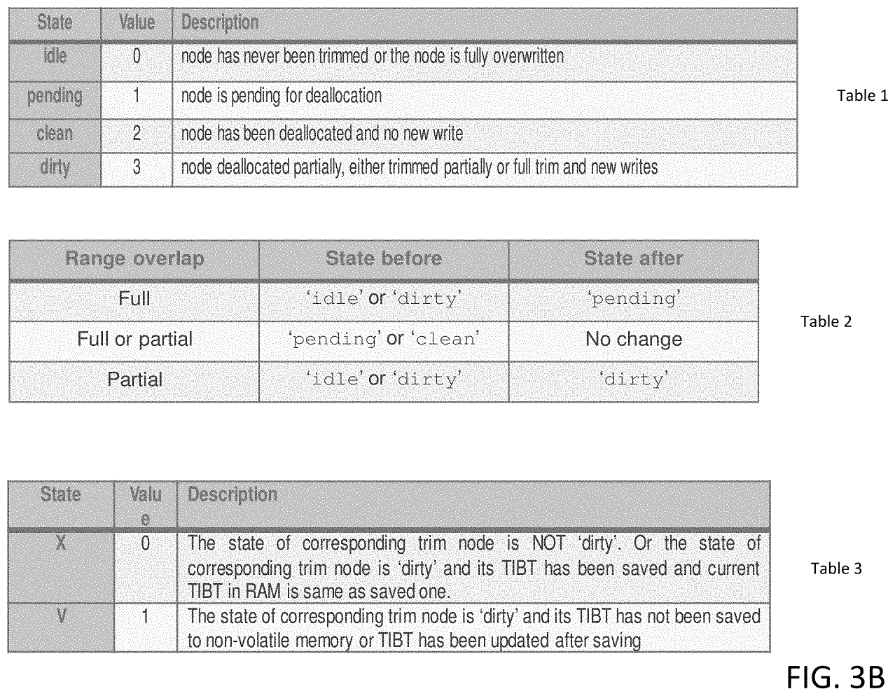

FIG. 3A is a block diagram 300 illustrating trim context containing multiple auxiliary tables in accordance with one embodiment of the present invention. Diagram 300 includes LBAs 302 addressing NVM storage space and trim context 306. Trim context 306 includes TIBT 308, TNST 310, and TSBT 312. In one embodiment, trim context 306 is stored in a volatile memory such as RAM (random-access memory) or SRAM (static random-access memory). It should be noted that the underlying concept of the exemplary embodiment(s) of the present invention would not change if one or more blocks (or devices) were added to or removed from diagram 300.

Diagram 300 discloses a storage system containing an NVM and a volatile memory wherein the NVM can store information persistently. The volatile memory stores information as long as it is powered by a power supply. In one example, the NVM is organized into multiple pages addressable by LBAs or PPA (physical page address). The volatile memory such as RAM is organized to host TIBT 308, TNST 310, and TSBT 312. In one embodiment, TIBT 308 is configured to contain entries wherein each entry is assigned to an LBA indicating status or recycling status of NVM indexed by LBA.

TNST 308 is configured to include multiple nodes wherein each node points to a group of TIBT entries indicating bit states associated with a group of TIBT. A function of TNST 308 is to quickly reference or index the location of TIBT 308 based on incoming LBAs. TNST 308 is smaller in size and it is easier to access. For example, if TIBT 308 has n entries and each node points 32K-entry of TIBT 308, the size of TNST is m=n/32K where m is the total number of nodes.

TSBT 312 is configured to identify which dirty node within TNST 310 needs to be saved during emergency power down. A function of TSBT 312 is to quickly index a location of TNST 310 based on the received LBA. During a backup procedure, TSBT 312 can be accessed to determine which part of TNST 308 should be saved during an unintended power failure.

An advantage of using a volatile memory to store TIBT 302, TNST 308, and TSBT 310 is to provide a better performance for handling trim command. It should be noted that a backup power supply can be used as a temporary power supply to trim context 306 for saving necessary content when the system power down is detected. In one embodiment, the backup power supply is a capacitor.

FIG. 3B illustrates three tables showing referencing status associated with TIBT, TNST, and TSBT in accordance with one embodiment of the present invention. TIBT, in one aspect, includes a bitmap wherein each bit indicates the validity of corresponding LBA. It should be noted that a trim command can invalidate storage space addressed by one LBA or a range of LBAs. TIBT is used to facilitate invalidation of LBAs based on information captured or recorded in the bitmap table. It should be noted that one bit within the bitmap corresponds to one LBA for NVM. For example, the bit is set to logic “1” if the corresponding LBA is trimmed (i.e., ready for recycling). Alternatively, the bit is cleared to logic “0”.

TNST, in one embodiment, includes multiple nodes wherein each node refers to a chunk. A chunk indicates a continuous configurable fixed number representing a group of consecutive bits in the bitmap of TIBT. For example, TNST, depending on the applications, divides the bitmap of TIBT into chunks (i.e., 32K for speed up reference time whereby the overall performance of trim command(s) process is improved. Table 1 in FIG. 3B illustrates 4 states for each node of TNST. Two (2) bits maybe needed to implement table 1. Table 1 shows that upon accessing node status, invalid bitmap table access, for example, is required when it is a ‘dirty’ state or will transition to ‘dirty’ state.

Table 2, in one embodiment, shows a process of a trim command that depending on the trim range, it can transition to ‘dirty’ or ‘pending’ or no state change. For every node which trim range overlaps, it will, for example, modify node state and invalid bitmap tables as shown in table 2. Table 2 also shows that ‘dirty’ state requires invalid bitmap table modification. Newly trimmed LBAs will set corresponding bits in the table set. After all ranges processed, trim can return a completion message. Note that background tasks such as garbage collection may subsequently start running in background.

A background task or operation includes a process of pending node process task and an idle node identification task. Pending node processor task includes running periodically to process pending node(s). For each ‘pending’ node, it deallocates corresponding LBAs and then change state to ‘clean’. Idle node identification task includes running periodically if there is any ‘dirty’ node. If corresponding TIBT has all zero bits in the node, the node state to ‘idle’ is changed.

To preserve content of trim context in a volatile memory during an unexpected power down, a scheme of trim context safe power down is implemented. In one aspect, upon detecting a system power failure, the content of trim context is saved in a predefined location of NVM using a temporary backup system. The exemplary embodiments illustrate scenarios when trim context is shut down on a condition of safe power down and unsafe power down.

In one aspect, trim context can be shut down in a condition of safe power down. For example, the drive can save all NVM context and mapping on safe power down if all pending node can be processed before power down. For example, invalidating all trim context if nothing needs to be saved. If there still not processed pending node, the process changes all states except ‘pending’ to ‘idle’ and saves TNST (Trim node state table) to NVM area including pointer(s).

Alternatively, trim context proceeds with following steps during a condition of unsafe power down. If there is no provision for power fail such as backup power supply, it will lose all data not saved to NVM area because there is insufficient amount of time to save necessary trim context before it is powered down. To properly save the necessary trim context, a backup temporary power supply such as a capacitor is employed. For example, if drive is equipped with the capacitor for power fail, it can save some critical information before the system power goes down. A sequence of trim context saving process includes saving a portion of TIBT corresponding to all trim node with ‘dirty’ state and TNST.

In one embodiment, a power saving scheme is able to provide dynamic snapshot of trim context. For example, if power fail capacitor is not big enough to hold for all trim context saving, the process is able to reduce the amount of trim context needed to save by flushing out part or all trim context on demand during normal drive operation. It should be noted that flushing (dynamic snapshot) is controlled by not-saved ‘dirty’ trim node count. If the count exceeds the predefined threshold, snapshot is triggered to flush out ‘dirty’ trim nodes. The amount of flushing and which nodes need to be flushed is configurable. It can flush all or part of dirty nodes

TSBT can also be used for dynamic snapshot of trim context wherein the process is able to provide data structure capable of identifying which ‘dirty’ node need to be saved. One bit for each node. Table 3 in FIG. 3B illustrates state and bit value to indicate the status of recycling. To implement table 3, a trim snapshot node counter may be needed. For instance, the trim snapshot node counter counts the number of trim nodes with state ‘V’ in TSBT. Also, the trim snapshot node counter is compared to set threshold to trigger flushing of trim context

Upon restoration of system power, a recovery of trim context is implemented. For example, the recovery of trim context read out saved trim context from NVM and changes all ‘clean’ state node to ‘pending’ state. After NVM context restoration, the recovered trim context can be processed. It should be noted that all ‘pending’ state node processing can be delayed to background task. Dirty node processing can be executed immediately or can be delayed for faster drive ready time.

During an unexpected power down, delayed dirty node processing can be processed after recovery of power. For example, background processing generally handles small number of nodes per run partially due to waking-up periodically. For example, process all ‘dirty’ trim nodes after crash recovery from node 0 till last node in sequential order. Pointer to currently being processed ‘dirty’ node is maintained and is used to compare for read command handling since read command can also process dirty trim node which is called Crash recovery Dirty Node processing Pointer (“CDNPtr”). In one embodiment, the power saving scheme utilizes a temporary additional bitmap table to coordinate deallocation processing between current task and read command.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

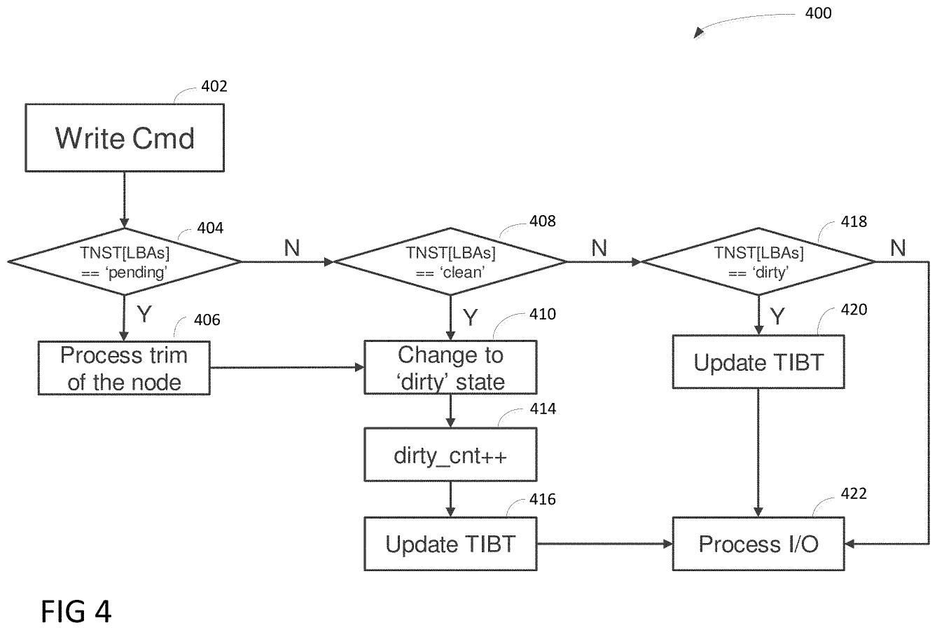

FIG. 4 is a flowchart 400 showing a process of a write command using a TNST in accordance with one embodiment of the present invention. Upon receiving a write command at block 402, the process examines at block 404 to see whether trim node(s) corresponding to the LBAs (“TNST [LBAs]”) is in a pending state. If it is, the trim of the node at block 406 is processed. If, at block 404, the TNST[LBAs] is not in a pending state, the process proceeds to block 408 and checks to see whether TNST[LBAs] is in a clean state. If it is, the process proceeds to change the state to dirty state at block 410. After incrementing the dirty counter at block 414, the content of the corresponding chunk of TIBT, at block 416, is updated. If the TNST[LBAs], at block 408, is not in a clean state, the process proceeds to block 418 and checks to see whether TNST[LBAs] is in a dirty state. If it is, the process proceeds to block 420 and updates the content of the corresponding chunk of TIBT. If, at block 418, TNST[LBAs] is not in a dirty state, the process proceeds to process I/O command at block 422.

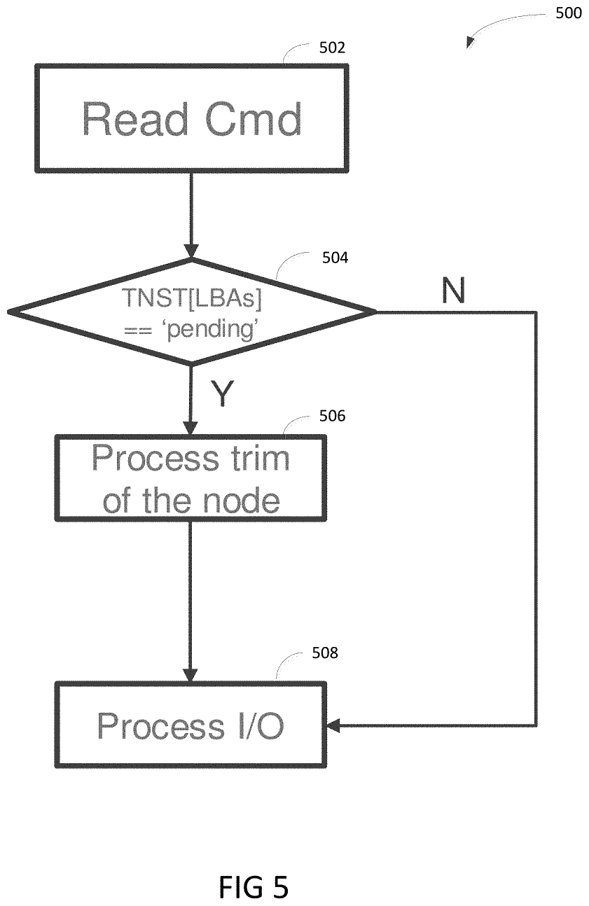

FIG. 5 is a flowchart 500 showing a process of a read command using TNST in accordance with one embodiment of the present invention. At block 502, upon receiving a read command, the process, at block 504, examines to see whether TNST[LBAs] is in a pending state. If it is, the trim of the node, at block 506, is processed and I/O is processed and trim node are deallocated at block 508. If the TNST[LBAs] is not in a pending state, the process, at block 504, proceeds to execute the I/O process at block 508.

A process of backing up information relating to the trim command for emergency power loss is able to detect an unintended system power loss. A backup power supply, in one embodiment, is activated to maintain a backup operation for a limited period time which should be sufficient to save the trim deallocation information from the volatile memory to NVM. In operation, the process identifies and retrieves content from TNST indicating the current states of TIBT. The current states of TIBT, for example, indicates the memory deallocation status associated to LBAs in the local memory. Upon processing and extracting at least a portion of TNST reflecting the status of TIBT, the portion of TNST is transferred from the location memory to a predefined location of NVM. For example, after extracting a portion of TIBT corresponding to all trim nodes with ‘dirty’ state, the portion of TIBT is stored in a predefined NVM location designated for storing TIBT before powering down.

Upon restoration of the system power, the stored trim context is retrieved from NVM back into the volatile memory for continuing execution of trim command. In operation, at least a portion of TSBT indicating a snapshot of the TNST shortly before the detection of the system power loss. The portion of TSBT is transferred from the predefined NVM location designated for storing TSBT before emergency power loss to the volatile memory.

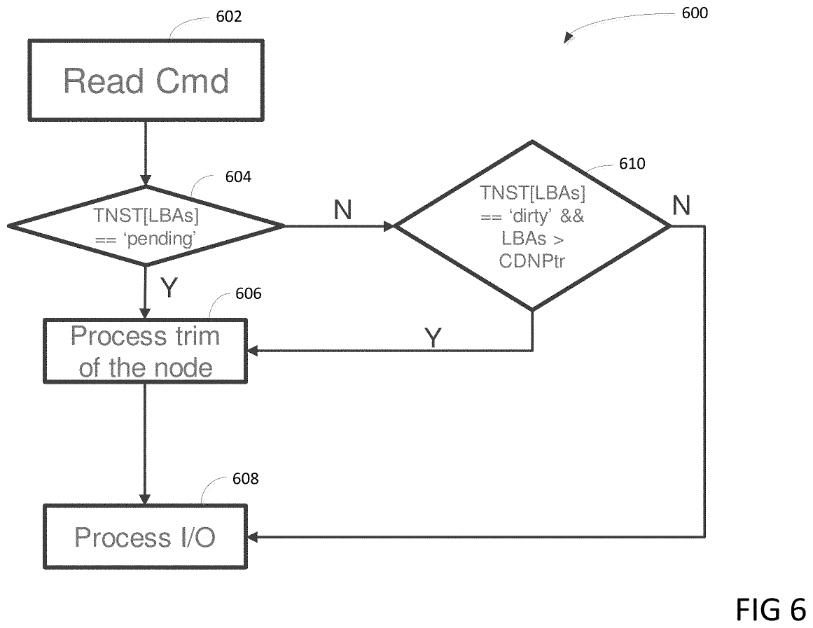

FIG. 6 is a flowchart 600 showing a process of a read command immediately after restoration from power failure (or a crash recovery) using TNST in accordance with one embodiment of the present invention. Upon receiving a read command at block 602, the process at block 604 examines to see whether TNST[LBAs] is in a pending state. If it is, the trim of the node is processed at block 606, and the I/O is subsequently processed at block 608. If the TNST[LBAs] is not in a pending state at block 604, the process proceeds to examine whether TNST[LBAs] is in a dirty state and LBAs is greater than CDNPtr at block 610. If it is, the trim of the node is processed at block 606, and the I/O is subsequently processed at block 608. If it is not, the I/O process is executed at block 608. It should be noted that CDNPtr points to a dirty node currently being processed by background task in a sequential order.

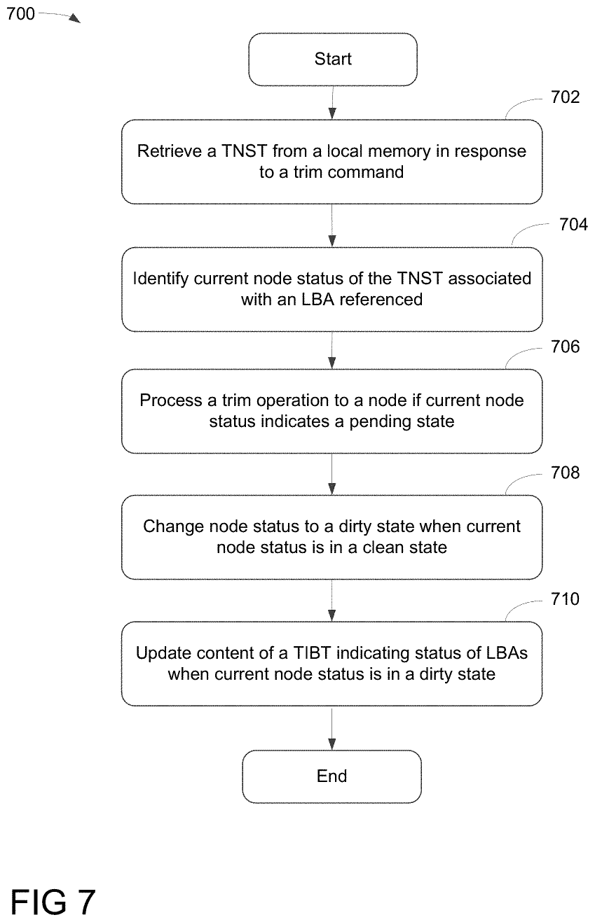

FIG. 7 is a flowchart 700 illustrating a process of implementing trim context in accordance with one embodiment of the present invention. At block 702, a process for processing I/O command to an SSD is able to retrieve a TNST from a local memory in response to a trim command.

At block 704, the process is capable of identifying current node status of the TNST associated with an LBA referenced by the trim command.

At block 706, a trim operation is processed to a node if the current node status indicates a pending state. In one example, after the node status is changed to a dirty state, the content of a dirty counter is incremented. The content of the TIBT subsequently is updated to reflect the result of processing and/or updating. The process is able to process the I/O command indicating a trim command when the current node status is in an idle state. TNST is used to index multiple entries of the TIBT. TSBT is used to indicate the node status for each node of TNST.

At block 708, changing the node status to a dirty state when the current node status is in a clean state.

At block 710, updating content of TIBT indicating status of NVM addressed by LBAs when the current node status is in a dirty state. It is noted that multiple entries of TIBT are indexed by a node entry of the TNST. For example, the process is capable of indicating status for each node of TNST by a trim snapshot bit table.

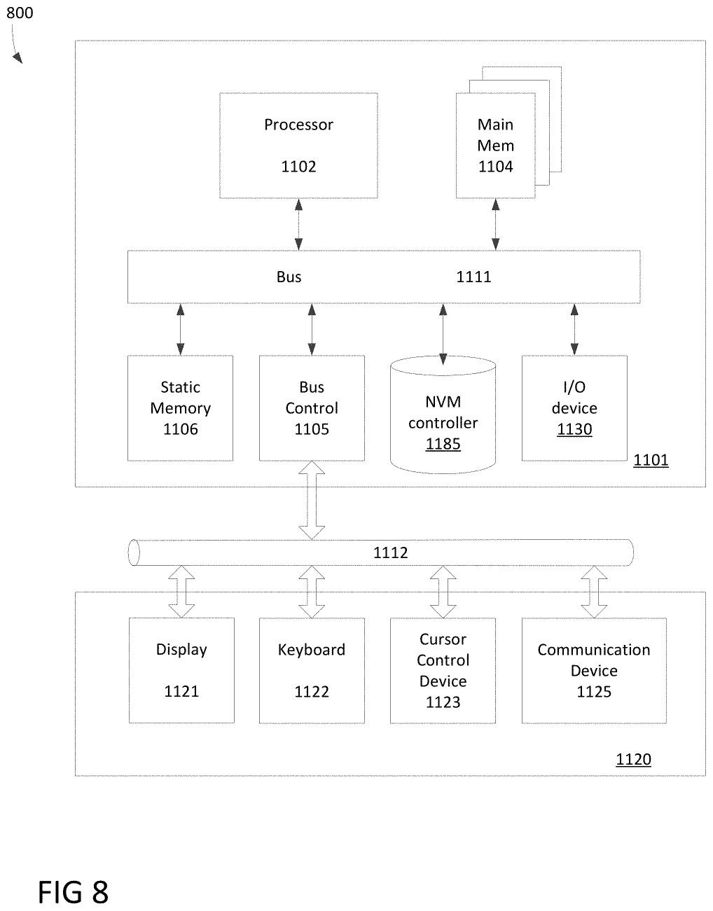

FIG. 8 is a block diagram 800 illustrating a digital processing system capable of operating data storage using SSD with a trim process in accordance with one embodiment of the present invention. Computer system or a signal separation system 800 can include a processing unit 1101, an interface bus 1112, and an input/output (“I/O”) unit 1120. Processing unit 1101 includes a processor 1102, a main memory 1104, a system bus 1111, a static memory device 1106, a bus control unit 1105, an I/O element 1130, and an NVM controller 1185. It should be noted that the underlying concept of the exemplary embodiment(s) of the present invention would not change if one or more blocks (circuit or elements) were added to or removed from FIG. 8.

Bus 1111 is used to transmit information between various components and processor 1102 for data processing. Processor 1102 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1104, which may include multiple levels of cache memories, stores frequently used data and instructions. Main memory 1104 may be RAM (random access memory), MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112. Mass storage memory or SSD, which may be a magnetic disk, an optical disk, hard disk drive, floppy disk, CD-ROM, and/or flash memories are used for storing large amounts of data.

I/O unit 1120, in one embodiment, includes a display 1121, keyboard 1122, cursor control device 1123, and communication device 1125. Display device 1121 may be a liquid crystal device, cathode ray tube (“CRT”), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

Communication device 1125 is coupled to bus 1111 for accessing information from remote computers or servers, such as server or other computers, through wide-area network. Communication device 1125 may include a modem or a network interface device, or other similar devices that facilitate communication between computer 1100 and the network.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for processing an input and output (“I/O”) command to a solid-state drive (“SSD”), comprising:
retrieving a trim node state table (“TNST”) from a local memory in response to a trim command;
identifying current node status of the TNST associated with a logical block address (“LBA”) referenced by the trim command;
processing a trim operation to a node if the current node status indicates a pending state;
changing the node status to a dirty state when the current node status is in a clean state; and
updating content of a trim invalid bitmap table (“TIBT”) indicating status of the LBAs when the current node status is in a dirty state.

2. The method of claim 1, further comprising processing the I/O command when the current node status is in an idle state.

3. The method of claim 1, wherein retrieving a trim node state table (“TNST”) includes loading the TNST from a nonvolatile memory to a volatile memory.

4. The method of claim 1, wherein processing a trim operation includes changing the node status to a dirty state.

5. The method of claim 4, wherein changing the node status to a dirty state includes incrementing content of a dirty counter.

6. The method of claim 5, wherein incrementing content of a dirty counter includes updating the content of the TIBT.

7. The method of claim 6, wherein updating the content of the TIBT includes processing the I/O command.

8. The method of claim 1, further comprising indexing a plurality of entries of the TIBT by a node entry of the TNST.

9. The method of claim 8, further comprising indicating node status for each node of TNST by a trim snapshot bit table.

10. An apparatus configured to store information, comprising:
a nonvolatile memory (“NVM”) configured to store information persistently and organized into a plurality of pages addressable by a plurality of local block addresses (“LBAs”);
a trim invalid bitmap table (“TIBT”) coupled to the NVM and configured to contain a plurality of entries wherein each entry is assigned to an LBA indicating status of the LBA; and
a trim node state table (“TNST”) coupled to the TIBT and configured to include multiple nodes wherein each node points to a group of TIBT entries indicating bit states associated with the group of TIBT.

11. The apparatus of claim 10, further includes a trim snapshot bit table (“TSBT”) coupled to the TNST and configured to identify which dirty node within the TNST needs to be saved.

12. The apparatus of claim 11, further includes a volatile memory configured to store the TIBT, the TNST, and TSBT for optimal performance.

13. The apparatus of claim 11, further includes a backup power supply configured to save content of the TSBT when power down is detected.

14. The apparatus of claim 13, wherein the backup power supply is a capacitor.

15. A method for backup information relating to trim command for a solid-state drive (“SSD”), comprising:
detecting an unintended system power loss;
activating a backup power supply to maintain a backup operation for a trim memory storing memory block deallocation information;
identifying and retrieving a trim node state table (“TNST”) indicating current states of a trim invalid bitmap table (“TIBT”) which represents memory deallocation status associated to logical block addresses (“LBAs”) from a local memory in response to the system power loss;
processing and extracting at least a portion of the TNST reflecting status of TIBT; and
storing the portion of the TNST in a predefined location of non-volatile memory (“NVM”).

16. The method of claim 15, further comprising extracting a portion of TIBT corresponding to all trim nodes with ‘dirty’ state and storing the portion of TIBT in a predefined NVM location designated for storing TIBT before powering down the backup power supply.

18. The method of claim 15, further comprising:
identifying a trim snapshot bit table (“TSBT”) indicating a snapshot of the TNST shortly before detection of system power loss; and
storing the TSBT in a predefined NVM location designated for storing TSBT before powering down the backup power supply.

19. The method of claim 15, further comprising:
retrieving a crash recovery dirty node processing pointer (“CDNPtr”) to continue a read command upon detection of power restoration; and
processing trim of the node if a TNST[LBA] state has a ‘pending’ state.

20. The method of claim 15, further comprising:
retrieving a crash recovery dirty node processing pointer (“CDNPtr”) to continue a read command upon detection of power restoration; and
processing trim of the node if a TNST[LBA] state has a ‘dirty’ state and LBAs are greater than the CDNPtr.
